(19) United States
(12) Patent Application Publication
(10) Pub. No.: US 2006/0021901 A1
(43) Pub. Date: Feb. 2, 2006

(54) Removable sampler

(76) Inventors: Sven Dobler, Huntington, NY (US); Dale Beal, Farmingdale, NY (US); Vincent Penna, Hampton Bays, NY (US)

Correspondence Address: Paul M. Denk;Ste. 170, 763 S. New Ballas Road, St. Louis, MO, 63141, US

(21) Appl. No.: 11/190,982

(22) Filed: Jul. 27, 2005

Related U.S. Application Data
(60) Provisional application No. 60/598,109, filed on Aug. 2, 2004.

(51) Int. Cl. B65D 69/00; B65D 73/00; B42D 15/00

(52) U.S. Cl. 206/581; 206/460; 229/92.8

(57) ABSTRACT

The removable sampler attaches to a card and then separates from the card after a journey through the mail. The removable sampler has a backer with one or more glue strips, and a sampler with one or more perforations and one or more tabs upon the glue strips but detaching from the perforation. Upon lifting, the sampler separates and detaches along the perforations. A tab remains behind in a magazine or a mail piece to meet postal regulations. The removable sampler uses permanent adhesive to affix the tabs to the backer. The sampler may include foil and no-foil structure packets, flow wraps, three sided and four sided seal pouches, and cosmetic or fragrance sampling items.

### CROSS REFERENCE TO RELATED APPLICATION

This nonprovisional patent application claims priority to the provisional patent application having Ser. No. 60/598,109, which was filed on Aug. 2, 2004.

### BACKGROUND OF THE INVENTION

This removable sampler relates to mail pieces in general and more specifically to an improved cosmetic sample upon a card. A unique aspect of the present removable sampler is a perforated sampler that detaches from the card.

People have adorned themselves with perfumes and colognes for centuries. A person usually seeks out and tries a perfume before purchasing it. To introduce new perfumes and to advertise other perfumes, perfume purveyors send samples by mail directly, or in magazines targeted to consumers. Using the mail invokes the jurisdiction of the U.S. Postal Service and other mailing authorities.

The U.S. Postal Service has various and multiple guidelines that regulate, limit, and prescribe sampling items in the mails. Sampling items when included in mail must keep the mail piece within bulk postage rate criteria, direct mail rules, and magazine regulations.

The present art overcomes the limitations of the prior art. That is, in the art of the present invention, a removable sampler, installs integrally with a backer and detaches readily by a consumer without incurring increased postal rates.

The difficulty in providing a removable sampler is shown by the operation of a typical product sample sent in catalogs or magazines through the mail. In times past, samples or packets have been glued upon a backer card with a glue spot that peels off. The backer cards are then bound into magazines and catalogs, or placed into direct mail pieces. As the samples are fully removable from a mail piece, the Postal Service levies an additional fee for these mailings. To avoid this fee, some perfume purveyors have limited their use of samples to newsstand sales of magazines only. Faced with this fee, perfume purveyors have limited their use of samples and packets in the U.S. mail.

The present invention overcomes the difficulties of installation, binding, and detaching of samplers along with the additional postal fees encountered in mailing.

### SUMMARY OF THE INVENTION

The removable sampler readily attaches to a card and then separates from the card after a journey through the mail. The removable sampler has a backer with one or more glue strips, and a sampler with one or more perforations and one or more tabs attached to the glue strips but detaching from the perforation by a consumer. The present invention incorporates a perforated tab on the top and bottom ends of the sampler. The tabs affix permanently to the backer as in a carrier card or magazine page. Upon lifting the sampler, the sampler separates and detaches along lines of perforations. A portion of the sampler, or the tab, remains behind in a magazine or a mail piece. The remainder of the sampler conforms to postal regulations as a non-fully removable mail item and increases the viability of mailing perfume samples. Further, the present invention more securely affixes to a backer card or magazine page and aids handling of the cards during bindery and reduces premature separation of the sample during assembly of the mail piece.

Preferably, the removable sampler uses permanent hot melt adhesive to affix the tabs to the backer. Adhesives, cohesives, heat seal bonders, ultraviolet curing adhesives, and others may also see use to permanently bond the tab of the sampler to the carrier card or magazine page. The sampler has packaging surrounding contents, such as cosmetic, fragrance, and other consumer products. By way of example, the packaging for the contents may have foil and no-foil structure packets, manufactured over-wrapped pouches, flow wraps, and three sided and four sided seal pouches.

### BRIEF DESCRIPTION OF THE DRAWINGS

FIG. 1 shows an exploded view of the preferred embodiment of the removable sampler constructed in accordance with the principles of the present invention;

FIG. 2 shows a plan view of the assembled removable sampler of the present invention; and,

FIG. 3 shows a plan view of the sampler detached from the backer.

### DESCRIPTION OF THE PREFERRED EMBODIMENT

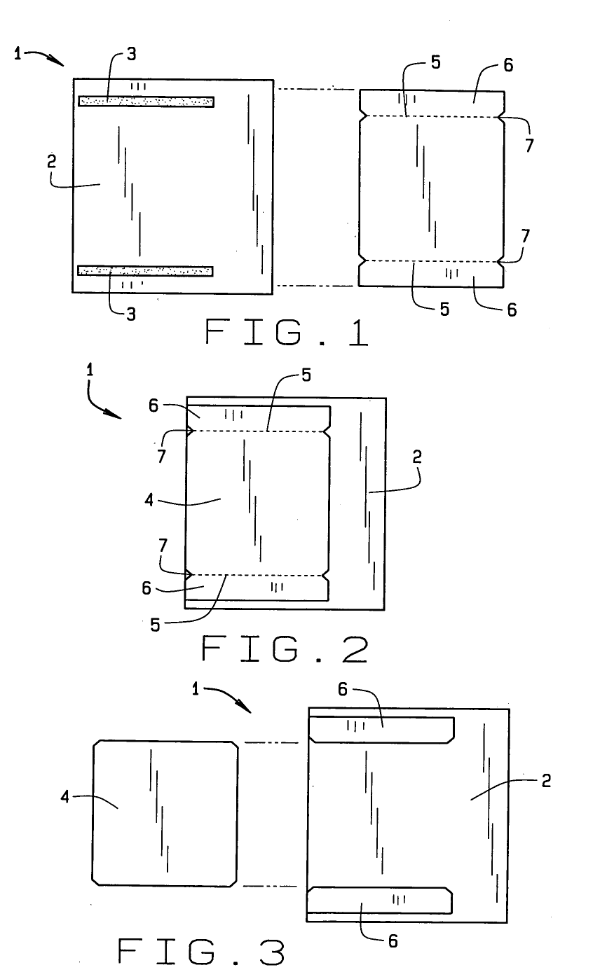

The present art overcomes the prior art limitations by providing a removable sampler device 1 with a portion permanently affixed to save postage and a detachable portion for delivering a sample to a consumer. Turning to FIG. 1, the pieces of the preferred embodiment of the removable sampler device 1 are arranged in a plan view. The backer 2 has a generally rectangular shape here with the longitudinal axis oriented vertically and a thin cross section making the backer 2 into sheet form. Two glue strips 3 have a generally liner shape and are mutually parallel and spaced apart near the perimeter of the backer 2. The glue strips 3 are parallel to the lateral axis and extend partially or fully across the width of the backer 2.

Then the sampler 4 also has a generally rectangular shape and sheet form though of lesser width and length than the backer 2. The sampler 4 has two mutually parallel and spaced apart tabs 6 parallel to the lateral axis. The tabs 6 join the lateral ends of the sampler 4 at perforations 5. The perforations 5 have a generally linear shape also parallel to the lateral axis. The perforations 5 define the width of a tab 6 at approximately less than one third the length of the sampler 4. At each end, a line of perforations 5 has a generally triangular shaped notch 7 to assist in tearing the sampler 4 from the backer 2 by the consumer.

As shown in FIG. 2, the removable sampler 4 assembles for mailing. The sampler 4 is positioned over the backer 2 with the tabs 6 above the glue strips 3. After positioning, the sampler 4 is pressed and secured to the backer 2. The perforations 5 and lateral edges of the backer 2 and the sampler 4 are parallel to the lateral axis of the backer 2. The sampler 4 is also generally centered upon the backer 2.

Upon delivery to a consumer, a consumer may detach the removable sampler 4 from a piece of mail as shown in FIG. 3. A consumer grasps the sampler 4 between the perforations 5 and then pulls at one notch 7. The consumer separates the sampler 4 from one tab 6 at the perforation. The consumer then separates the second tab 6 from the second perforation to remove the sampler 4 from the mail piece. The consumer then partakes of the product sample.

From the aforementioned description, a removable sampler has been described. The removable sampler is uniquely capable of permanent attachment by printers to save postage and of detaching a portion of the sampler by a consumer. The removable sampler and its various components may be manufactured from many materials including but not limited to clay coated paper, cardstock, cardboard, chipboard, fiberboard, polymers, high density polyethylene, polypropylene, polyvinyl chloride, nylon, ferrous and non-ferrous metal foils, their alloys, and composites.

We claim:

1. A device for sending cosmetics, fragrances, and the like through the mail to a consumer comprising:
a backer, having one or more glue strips; and,
a sampler, having one or more perforations, and one or more tabs upon said sampler adhering to said glue strips and detaching from said perforation by a consumer.

2. The device of claim 1 wherein said backer is cardstock, a magazine insert, a catalog page, or a direct mail piece.

3. The device of claim 2 further comprising:
said backer having a generally rectangular shape with said glue strip parallel to the lateral axis of said backer and proximate to the perimeter of said backer; and,
said sampler having a generally rectangular shape of lesser width and lesser length than said backer;
whereby said tab is placed upon said glue strip joining said sampler to said backer.

4. The device of claim 3 wherein said perforations have a generally linear shape with notches at opposite ends.

5. The device of claim 3 wherein said sampler incorporates a sample of cosmetics, fragrance, or consumer product.

6. The device of claim 2 further comprising:
said backer having a generally rectangular shape with two mutually parallel and spaced apart glue strips parallel to the lateral axis of said backer and proximate to the perimeter of said backer; and,
said sampler having a generally rectangular shape of lesser width and length than said backer;
whereby said tabs are placed upon said glue strips joining said sampler to said backer with their longitudinal axes parallel for travel through the mails.

7. The device of claim 6 wherein said perforations have a generally linear shape, mutually parallel, and spaced apart with notches at opposite ends.

8. The device of claim 6 wherein said sampler incorporates a sample of cosmetics, fragrance, or consumer product.
